(19) United States
(12) Patent Application Publication
(10) Pub. No.: US 2015/0247969 A1
(43) Pub. Date: Sep. 3, 2015

(54) Hollow Backlight Unit

(71) Applicant: Synopsys, Inc., Mountain View, CA (US)

(72) Inventors: Simon Magarill, Cincinnati, OH (US); David R. Jenkins, Nampa, ID (US)

(21) Appl. No.: 14/309,729

(22) Filed: Jun. 19, 2014

Related U.S. Application Data
(60) Provisional application No. 61/947,219, filed on Mar. 3, 2014.

(51) Int. Cl. F21V 8/00; G02F 1/1335

(52) U.S. Cl. CPC G02B 6/0096; G02F 1/133603; G02F 1/133605; G02F 2001/133607

(57) ABSTRACT

A hollow backlight unit preserves the benefits of a conventional backlight based on a solid light guide, but has lower weight and cost. The hollow cavity of the unit has a flat reflective bottom, three reflective side surfaces, LEDs placed in a hollow edge reflector on the fourth side, and a top layer with light extracting features that covers the entire viewing area of the hollow backlight unit. The hollow backlight can be used together with an additional diffuser on the top to avoid cross-talk between the light extracting features and LCD pixels. It can also be combined with optical films like BEF/DBEF to enhance efficiency and control view angle performance.

### CROSS-REFERENCE TO RELATED APPLICATION

This application claims the benefit of U.S. Provisional Application No. 61/947,219, filed Mar. 3, 2014, which is incorporated herein by reference in its entirety.

### BACKGROUND

1. Field

The disclosure relates generally to backlight units and specifically to backlight units having a hollow cavity.

2. Description of the Related Art

Conventional light-emitting diode (LED) backlight units (BLUs) employ a solid light guide with different LED locations and various combinations of optical films, such as described by Yourii Martynov, Huub Konijn, Nicola Pfeffer, Simon Kuppens and Wim Timmers, “High-efficiency slim LED backlight system with mixing light guide,” SID DIGEST, 1-3, 2003. Such a light guide is usually made of optical plastic that serves as a solid light guide, which adds weight and cost to the BLU.

The architecture of a backlight that uses a hollow cavity (no light guide) is described, for example, by Ryuji Tsuchiya, Yoji Kawasaki, Shota Ikebe, Toshiaki Shiba, Junichi Kinoshita, “Thin Side-Lit, Hollow-Cavity Flat LED Lighting Panel for Ultra-Uniform LCD Backlight Applications,” SID DIGEST, 847-877, 2008. This approach uses a non-flat specular (or possibly diffuse) reflector on the bottom of a cavity to control illuminance uniformity across the viewable area of the backlight. This reflector is of a geometry that is extruded in the direction of LED arrays located along one or two opposite sides of the hollow cavity backlight. This geometry allows for control of the illuminance distribution across the viewable area of the BLU only in the direction perpendicular to the LED array(s) and not in the direction parallel to the LED arrays. This is a problem for spreading the light in the direction parallel to the LED arrays near the LEDs to maintain illuminance uniformity of the BLU near the edge of the display (near the LED sources). Such an extruded reflective bottom of the hollow cavity does not change the light mixing in the direction along the backlight edge along which light sources such as LEDs are located. This means that the LED pitch will need to be small enough to eliminate illuminance variation along the backlight edge near the LEDs or that a certain mixing distance must be maintained outside the viewable area of the BLU (which is disadvantageous to modern “borderless” LED display designs). Also, this approach does not work with the case when light sources are located along all 4 sides of the hollow cavity.

### SUMMARY

Embodiments disclosed include a backlight unit (BLU) having a hollow cavity. The hollow cavity reflects light from the side surface(s) and top and bottom surfaces of the cavity. Extracting features on the top surface are employed to extract light from the cavity in a controlled manner. For example, transmissive holes in the top surface may be used. The holes may have the same size while the density of the holes varies across the surface of the BLU to provide the desired level of uniformity of light extraction. Alternatively, the density of the holes may be uniform across the BLU while the size of the holes varies to maintain the desired uniformity of extracted light. The holes may be round, square, rectangular, or any other shape or combination of shapes. In another implementation, various three-dimensional elements can be used as the extracting feature instead of holes, such as small lenses, prisms, and the like. In addition, the top and/or bottom of the BLU hollow cavity can have specular or diffused reflectivity.

A hollow BLU provides the same uniformity and efficiency as the conventional BLU having a solid light guide, but the hollow BLU has lower weight and lower material cost. The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 illustrates the general architecture of a hollow backlight unit in accordance with an embodiment of the invention, in contrast to the convention backlight unit.

FIG. 2A illustrates the simulated illuminance of a conventional solid backlight unit.

FIG. 2B illustrates the simulated illuminance of a hollow backlight unit in accordance with an embodiment of the invention.

FIG. 3A illustrates the angular intensity distribution of a hollow backlight unit with specular reflection from the bottom in accordance with an embodiment.

FIG. 3B illustrates the angular intensity distribution of a hollow backlight unit with Lambertian reflection from the bottom in accordance with another embodiment.

One skilled in the art will readily recognize from the following discussion that alternative embodiments of the structures and methods illustrated herein may be employed without departing from the principles described herein.

### DETAILED DESCRIPTION

Conventional backlight units (BLUs) for LCD and for signage applications comprise light sources (typically LEDs), a specially designed light guide, a reflector component beneath the light guide, and optional optical films stacked above top surface (viewable area) of the BLU. The light guide structures are normally designed by optical engineers using illumination design software such as Synopsys LIGHTTOOLS® to optimize the optical features on the top or on the bottom surface of the light guide to achieve the desired illuminance uniformity on the top (viewable area) of the light guide. Typically these light guides are made from molded clear plastic. The optical features used to extract the light from the light guide are typically small painted dots or small molded 3D structures such as protrusions (bumps) or indentations (holes) on the top or on the bottom of the light guide surface. The location or size of these optical features is optimized to create the desired illuminance uniformity on the top of the backlight. A problem with this approach is that the solid plastic light guide itself is heavy; moreover, it contributes to the cost of the backlight unit through material and fabrication cost as well as inventory costs of the light guide.

Embodiments disclosed reduce the weight and cost of a backlight unit for liquid crystal display (LCD) and other display applications. In contrast to the non-flat reflector on the bottom of the cavity proposed by Tsuchiya et al. discussed above, embodiments disclosed use a substantially flat reflective bottom of the hollow cavity (which can be fabricated at a lower cost than the non-flat bottom reflector approach) with a substantially flat top reflective surface containing holes which are configured to control the uniformity of output light from the hollow cavity backlight unit. The reflective top and bottom of the cavity can have specular or diffuse reflectivity. The light extracting layer (on the top) can be described as a plurality of holes in the reflective layer on the optically clear cover of the hollow cavity. The reflective layer with holes may be placed on a clear cover material, a brightness enhancement film (BEF), a dual brightness enhancement film (DBEF), or potentially on the glass of the LCD itself (or on a substrate of the mask used in signage applications). The location, size and density of the holes in the reflective layer may be optimized to achieve the desired illuminated BLU illuminance uniformity. Technology to make holes in a reflective layer or coating (e.g., a reflective film or reflective coating on a film or glass substrate using photolithography etching) is well known to those of skill in the art. In another implementation, various three-dimensional elements can be used as the extracting feature instead of holes, such as small lenses, prisms, and the like. Alternatively, the light extraction features on the top surface comprise transmissive or partially transmissive areas having less reflectivity or absorption than areas surrounding the light extraction features of the top surface.

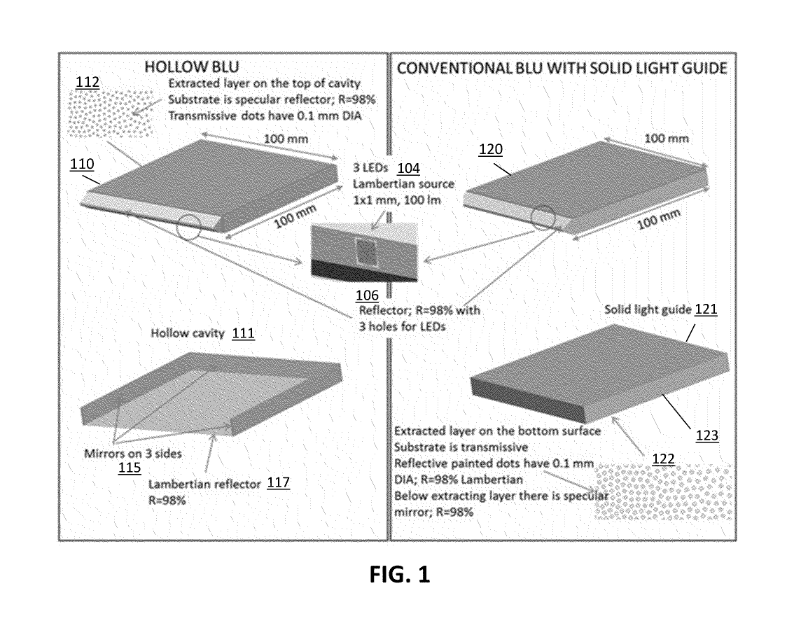

FIG. 1 illustrates the general architecture of a hollow backlight unit 110 in accordance with one embodiment, in contrast to the convention backlight unit 120. The differences in the assemblies illustrated in FIG. 1 are:
The hollow BLU 110 does not have a solid light guide 121. The absence of a solid light guide results in lower weight and lower cost as compared to the conventional BLU 121.
The hollow BLU 110 does not have an additional component (specular mirror 123) on the bottom. It is replaced with an off-the-shelf diffusing or specular reflective film which can be laminated or deposited on a mechanical part of the assembly of the hollow BLU 110 at a lower cost than the additional component in the conventional BLU 120.
The hollow BLU 110 has light extraction features 112 comprising transmissive dots (holes) in a reflective layer on the top of the hollow cavity 111 through which extracted light passes versus reflective structures 122 on the bottom of the light guide in the illustrated conventional BLU 120.

In the example illustrated in FIG. 1, a 100×100 millimeters (mm) BLU 110, 120 has been used, but the size and thickness of the backlight unit can be changed as needed for the specific applications. For example, the thickness of the backlight unit may range from approximately 1 mm to 20 mm or more in various implementations. In the example illustrated in FIG. 1, three equally spaced LEDs 104 are used as light sources but the same design concept can be used for a backlight with various number of LEDs, with different colored LEDs or with any other light sources, such as organic light-emitting diodes (OLED) or fluorescent lamps. In this example, LEDs are placed on one side of a hollow cavity 111, and the other three sides are reflective mirrors 115, but it is also possible to place LEDs 104 on the opposite sides of BLU cavity 111 or on all four sides. The light sources may be placed directly at the edge of the hollow cavity 111, or may be embedded in light reflectors 106 of various depths. The main purpose of any light reflectors 106 around the light sources is to direct light into the hollow cavity 111 and prevent light leakage from the cavity 111, which would negatively impact the efficiency of the BLU 110. In this design example, a hollow reflector 106 with plano specular reflective surfaces is used to collect light from the LEDs 104 and direct it into the hollow cavity 111 of the BLU 110. Other collecting optics can be used as well, such as a refractive condenser, a compound parabolic concentrator (CPC-type component), or a total internal reflection (TIR) lens. Optimum density or size distribution for the extracting features 112 on the top of the hollow cavity 111 depends on the type, quantity and placement of the light sources.

Normally, on the top of a traditional BLU 120 there are one or more optical films such as a BEF, a DBEF, or an additional diffuser. It is noted that the hollow BLU 110 can use the same films as a conventional BLU 120 for the same purposes.

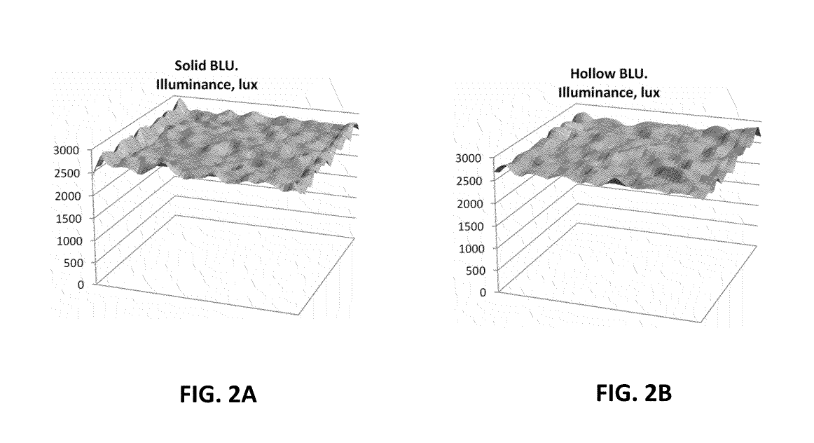

FIG. 2A illustrates the simulated illuminance of a conventional solid backlight unit, whereas FIG. 2B illustrates the simulated illuminance of a hollow backlight unit in accordance with an embodiment of the invention. In this example, the performance was simulated using the LIGHTTOOLS® optical engineering and design software product available from Synopsys, Inc. of Mountain View, Calif. Efficiency is calculated as the ratio of light coming out of the BLU viewable area over light generated by the LEDs. In the illustrated examples, the efficiency of the solid BLU is 71% and the efficiency of the hollow BLU is 76%. Contrast ratio (CR) is calculated as (max−min)/(max+min) where min is the minimum illuminance and max is the maximum illuminance within viewable area of the top surface of the BLU. In the illustrated examples, the contrast ratio for the solid BLU is 0.072, and the contrast ratio for the hollow BLU is 0.075

It can be seen that with practically identical uniformity, within the limits of stochastic noise of the simulation, the hollow backlight has slightly better efficiency than the convention BLU, which implies that the hollow BLU provides adequate uniformity with fewer ray reflections inside the cavity.

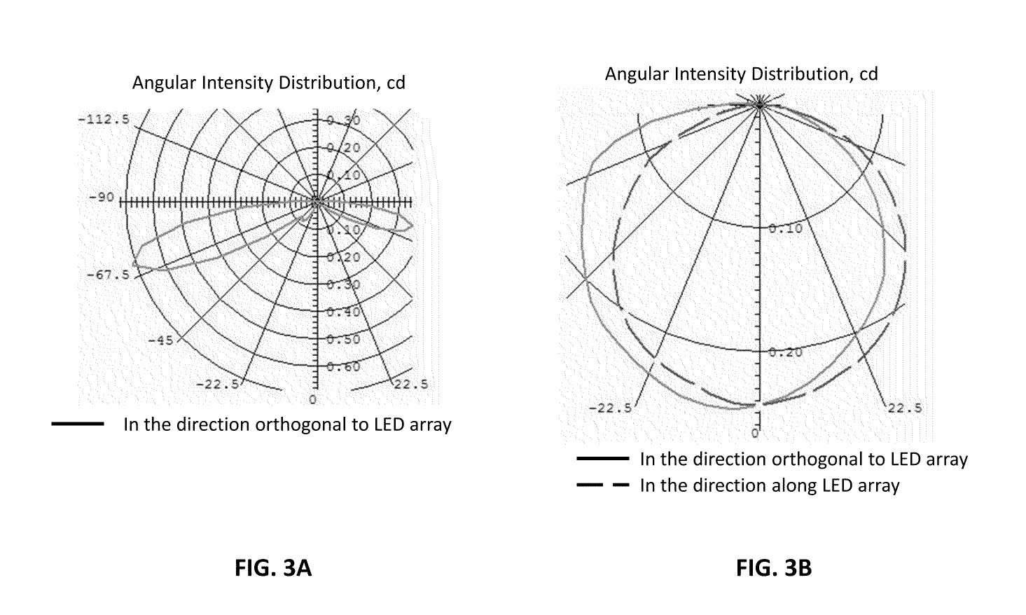

The top and bottom reflective layers can have a specular or a scattering reflectivity. FIG. 3A illustrates the angular intensity distribution of a hollow backlight unit with specular reflection from the bottom in accordance with an embodiment. FIG. 3B illustrates the angular intensity distribution of a hollow backlight unit with Lambertian reflection from the bottom in accordance with another embodiment.

With an LED array on one side as shown in FIG. 1, the specular reflective bottom surface creates an unwanted angular light intensity distribution from the hollow BLU as shown in FIG. 3A. Such light behavior may require an additional diffuser on the top of the BLU to redistribute light in the direction orthogonal to the unit.

Using a Lambertian scattering reflector 117 on the bottom of the hollow cavity 111 creates near Lambertian light intensity angular distribution from the hollow BLU 110 as illustrated in FIG. 3B. This angular distribution is slightly tilted in the direction away from the LEDs 104 but this tilt is minor and the hollow BLU 110 can be used without an additional diffuser on the top. This configuration is applicable for signage applications; for employing a hollow BLU 110 with an LCD, the cross-talk between the extracting structure of the hollow BLU 110 and the LCD pixels should be addressed. In the case of using two rows of LEDs 104 on the opposite sides of hollow cavity 111, the tilt of the angular intensity distribution away from normal to the BLU surface is corrected and the light emerges from the hollow BLU 110 with symmetry about the normal to the hollow BLU surface.

In an alternative embodiment, a two-sided hollow backlight unit includes both a top and a bottom surface, each with light extracting features. In one implementation, the top and bottom surface of the two-sided hollow BLU may be identical extracting layers with identical light extraction features, whereas the remainder of the hollow BLU may be constructed as described with reference to FIG. 1. Diffuse (not specular) reflection can be employed on both of the extracting layer substrates above and below the hollow cavity of the BLU. A two-sided hollow BLU may be particularly beneficial for signage applications, where extracting layers on opposite sides can produce substantially uniform illuminance from one backlight, without doubling the cost of components of the one-sided hollow BLU 110.

In summary, the hollow BLU described herein offers many advantages as compared to conventional BLUs, primarily in terms of weight and cost. Also, the LED pitch is not limited as in the case of the curved bottom surface hollow light guide. This means fewer LEDs can be used and that the borders of the display can be smaller because light mixing is not required to get uniform illumination on the edges of the BLU. In some example embodiments, the hollow backlight unit can provide uniform illuminance even with one single LED used per backlight unit. Further, there is no need for any secondary optics to mix light from adjacent LEDs as would be required in the case of the curved bottom surface hollow backlight, thus resulting in lower weight and lower cost. For some applications, there is no need for a diffuser on top of the backlight unit as would be required in the case of the curved bottom surface hollow backlight. This increases system efficiency and lowers the cost of the BLU based on fewer LEDs or lower power LEDs being required.

Upon reading this disclosure, those of skill in the art will appreciate still additional alternative structural and functional designs. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the disclosed embodiments.

What is claimed is:

1. A hollow backlight unit without a solid light guide, the unit comprising:
a reflective bottom surface of a hollow cavity;
a top surface of the hollow cavity opposite the bottom surface, the top surface comprising light extraction features through which extracted light passes for backlight illumination, the light extraction features configured to control uniformity of output light of the backlight; and
at least one side surface of the hollow cavity adjacent to the top and bottom surfaces comprising at least one light source for introducing light into the hollow cavity.

2. The unit of claim 1, wherein the extracted light has substantially uniform illuminance across the top surface of the unit.

3. The unit of claim 1, wherein the light extraction features comprise a non-uniform density of holes, or a uniform density of holes of non-uniform size.

4. The unit of claim 3, wherein the light extraction features comprise holes of any shape or combination of shapes.

5. The unit of claim 1, wherein the light extraction features of the top surface comprise at least partially transmissive areas, the at least partially transmissive areas having less reflectivity or absorption than areas surrounding the light extraction features of the top surface.

6. The unit of claim 1, wherein the light extraction features comprise three-dimensional structures.

7. The unit of claim 6, wherein the three-dimensional structures comprise small lenses or prisms.

8. The unit of claim 1, wherein the bottom surface comprises a specular reflective surface.

9. The unit of claim 1, wherein the bottom surface comprises a diffused reflective surface.

10. The unit of claim 1, wherein the top surface comprises a specular reflective surface.

11. The unit of claim 1, wherein the top surface comprises a diffused reflective surface.

12. The unit of claim 1, further comprising:
at least one other side surface of the cavity adjacent to the top and bottom surfaces comprising at least one other light source for introducing light into the hollow cavity.

13. The unit of claim 1, wherein the at least one side surface of the cavity comprises four side surfaces of the cavity, each side surface comprising a respective at least one light source for introducing light into the hollow cavity.

14. The unit of claim 1, further comprising:
collecting optics around the at least one light source for introducing light into the hollow cavity.

15. The unit of claim 1, further comprising:
at least one reflective side surface of the hollow cavity adjacent to the top and bottom surfaces configured to reflect light back into the hollow cavity.

16. The unit of claim 1, wherein the bottom surface comprises light extraction features through which extracted light passes for backlight illumination.

17. The unit of claim 16, wherein the extracted light has substantially uniform illuminance across the bottom surface of the unit.

18. The unit of claim 16, wherein the light extraction features of the bottom surface are identical to the light extraction features of the top surface.

19. The unit of claim 16, wherein the bottom surface comprises a diffused reflective surface.

20. The unit of claim 16, wherein the top surface comprises a diffused reflective surface.

21. The unit of claim 1, wherein the reflective bottom surface is substantially flat.

22. A hollow backlight unit without a solid light guide, the unit comprising:
a reflective bottom surface of a hollow cavity;
a top surface of the hollow cavity opposite the bottom surface, the top surface comprising means for controlling uniformity of extracted light for backlight illumination; and
at least one side surface of the hollow cavity adjacent to the top and bottom surfaces comprising means for introducing light into the hollow cavity.

23. The unit of claim 22, wherein the reflective bottom surface is substantially flat.

24. The unit of claim 22, wherein the bottom surface comprises means for extracting light for backlight illumination.
